(19) United States
(12) Patent Application Publication
(10) Pub. No.: US 2013/0083530 A1
(43) Pub. Date: Apr. 4, 2013

(54) ILLUMINATION DEVICE

(71) Applicant: MIN-JET LUI, Chu-Nan (TW)

(72) Inventor: MIN-JET LUI, Chu-Nan (TW)

(73) Assignee: FOXSEMICON INTEGRATED TECHNOLOGY, INC., Chu-Nan (TW)

(21) Appl. No.: 13/489,445

(22) Filed: Jun. 5, 2012

(30) Foreign Application Priority Data
Sep. 29, 2011 (TW) 100135149

(51) Int. Cl. F21V 21/00

(52) U.S. Cl. 362/249.02; 362/249.01

(57) ABSTRACT

An illumination device includes a housing defining a hole therethrogh; a plurality of light sources each is a light emitting diode is disposed in the housing; a lamp seat is securely positioned at one side of the housing. The lamp seat comprises a protrusion configured to receive electronic elements therein. The protrusion of the lamp seat is inserted into the hole of the housing.

### BACKGROUND

1. Technical Field

The present disclosure relates to illumination, particularly to an illumination device with decreased thickness, and more particularly to a low-profiled LED (light emitting diode) ceiling lamp.

2. Description of Related Art

A traditional lamp generally includes a housing and a plurality of light sources mounting on the housing. A lamp cover is fastened to one side of the housing to cover the light sources, and a lamp seat is fastened to the other side of the housing to receive electronic elements therein for providing power for the light sources. In the lamp described above, the lamp seat positioned at one side of the housing will occupy a certain space thereto make the lamp have a relatively large thickness. When such a thick lamp is used as a ceiling lamp for a room with a relatively small height, a feeling of constriction will be exerted to a person in the room. Moreover, such a lamp is high power consuming.

What is needed, therefore, is an illumination device which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an illumination device according to one embodiment of the present disclosure.

FIG. 2 is an inverted view of FIG. 1.

FIG. 3 is an exploded view of the illumination device of FIG. 1.

FIG. 4 is an inverted view of FIG. 3.

### DETAILED DESCRIPTION

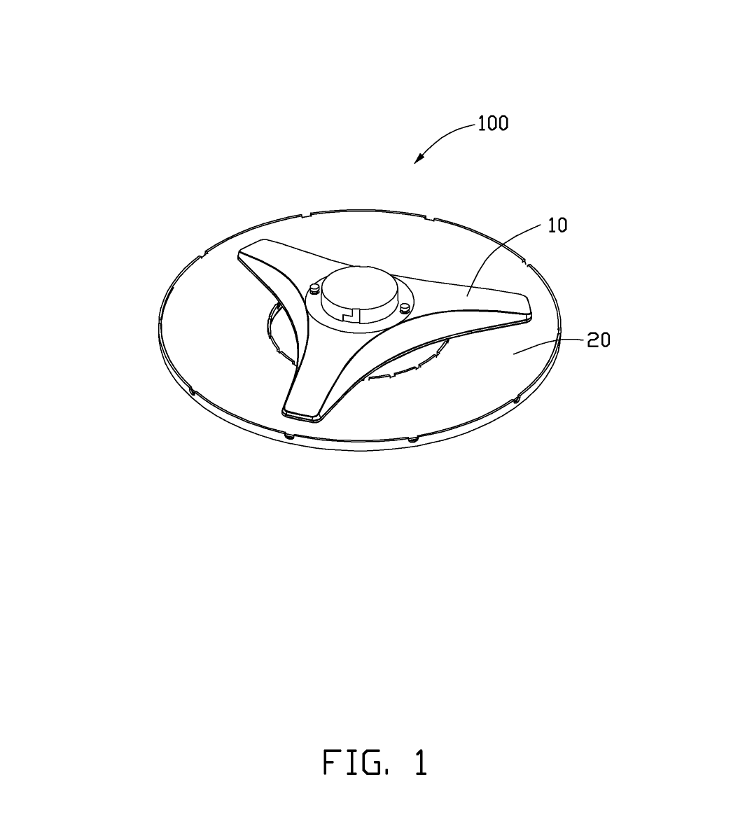

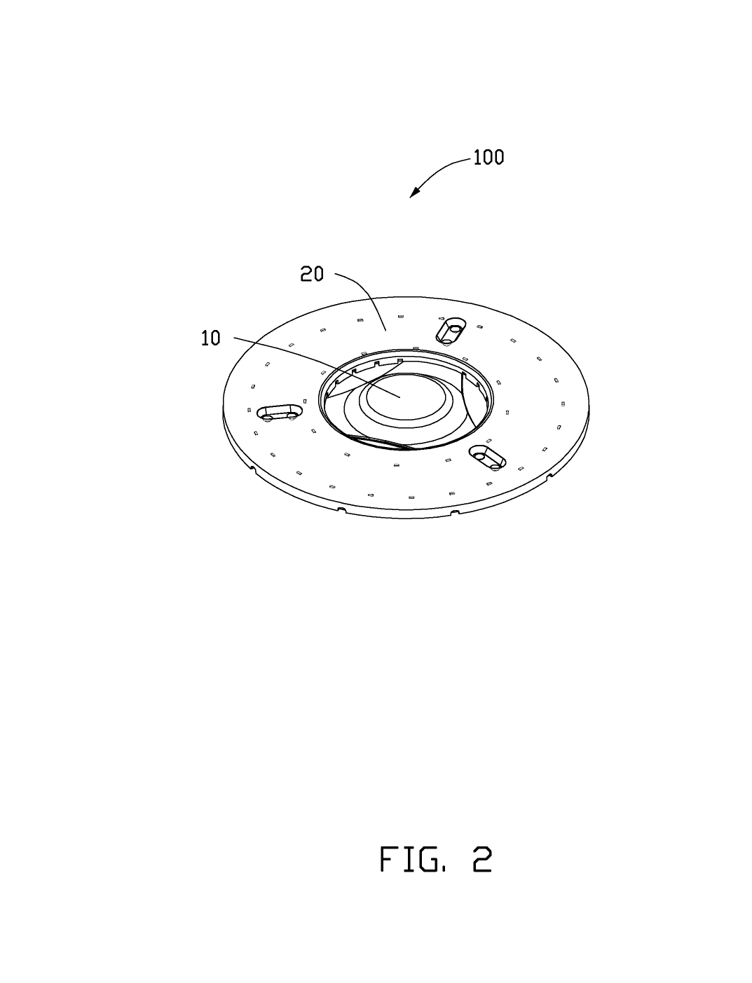

Referring to FIGS. 1-2, an illumination device 100 according to an embodiment of present disclosure includes a housing 20 and a lamp seat 10 fastened to one side of the housing 20. The illumination device 100 is particularly used as a low-profiled ceiling lamp with a light source consisting of light emitting diodes.

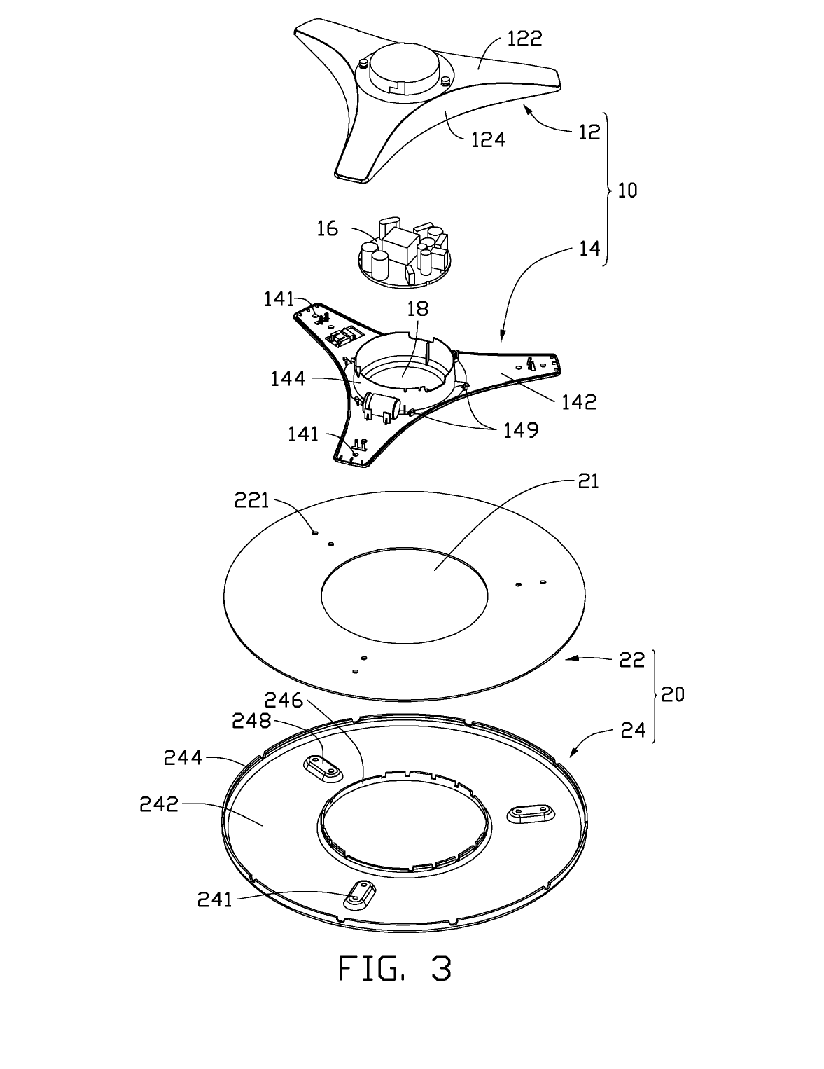

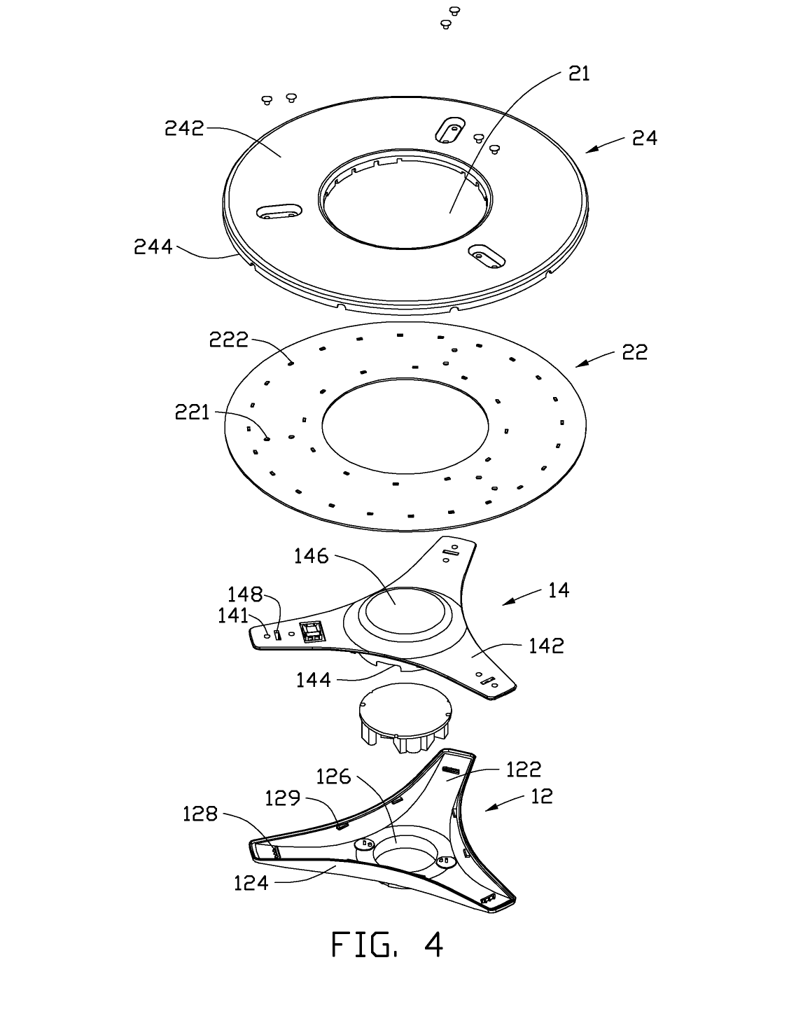

Referring also to FIGS. 3-4, the lamp seat 10 includes an upper cover 12 and a lower cover 14 interconnected together. Electronic elements 16 are received between the upper cover 12 and the lower cover 14.

The upper cover 12 has a substantially trilobate shape, and includes an upper plate 122 and three lateral plates 124 extending downwardly from the upper plate 122. A central portion of the upper plate 122 protrudes out away from the housing 20. Three lateral sides of the upper plate 122 are curved towards the central portion. In this embodiment, the three lateral plates 124 one-to-one correspondingly extend down from the three lateral sides of the upper plate 122. The lateral plates 124 are also curved towards the central portion of the upper plate 122. The upper plate 122 and the lateral plates 124 cooperatively form a receiving chamber 126 therebetween. Each corner of the upper plate 122 has a first buckle 128. The first buckle 128 extends downwardly from the upper plate 122 towards the housing 20. One end of the first buckle 128 is bent inwardly to form a hook to connect with the lower cover 14. Each lateral plate 124 has two snaps 129 extending horizontally and inwardly from an inner side thereof. The snaps 129 are configured to further strengthen the connection between the upper cover 12 and the lower cover 14.

The lower cover 14 has a similar configuration with the upper cover 12. The lower cover 14 includes a bottom plate 142 and an annular sidewall 144 on a central portion of the bottom plate 142. The sidewall 144 extends vertically from the bottom plate 142 to the upper cover 12. The central portion of the bottom plate 142 surrounded by the sidewall 144 protrudes outwardly away from the upper cover 12 and forms a protrusion 146 opposite to the sidewall 144. The protrusion 146 and the sidewall 144 cooperatively define a space 18 for receiving the electronic elements 16 therein. Each corner of the bottom plate 142 has a second buckle 148. The second buckle 148 extends from the lower cover 14 towards the upper cover 12. One end of the second buckle 148 is bent to form a hook to clasp with the first buckle 148. Each corner of the bottom plate 142 defines two holes 141 therein. Screws or rivets (not labeled) are used to extend through the housing 20 and secure in the holes 141 to fix the lamp seat 10 and the housing 20 together. The holes 141 can be blind holes or through holes.

The bottom plate 142 has a plurality of third buckles 149 one-to-one corresponding to the snaps 129 of the upper cover 12. The third buckles 149 extend from the bottom plate 142 to the upper cover 12. One end of each third buckle 149 is bent to form a hook to clasp with a corresponding one of the snaps 129 of the upper cover 12. Therefore, the connection between the upper cover 12 and the lower cover 14 is strengthened.

In assembly, the first buckles 128 of the upper cover 12 and the second buckles 148 of the lower cover 14 are clasped together. The receiving chamber 126 of the upper cover 12 and the space 18 inside the side wall 144 cooperatively receive the electronic elements 16 therein. In other words, one part of the electronic elements 16 is received in the space 18, and the other part of the electronic elements 16 is received in the receiving chamber 126 of the upper cover 12. Besides the trilobate shape, the lamp seat 10 can also substantially be a rectangle shape or a pentagonal shape.

The housing 20 is annular, and defines a hole 21 through a center thereof. Alternatively, the housing 20 can be other configurations with the hole 21 defined therein, and the hole 21 is not limited in the center of the housing 20. The lamp seat 10 is fastened to one side of the housing 20. The protrusion 146 is inserted into the hole 21, therefore, a thickness of the illumination device 100 can be decreased. Thus, the illumination device 100 has a low profile which is suitable to be a ceiling lamp for a room with a low height. In this embodiment, the housing 20 includes a base 22 and a cover 24. The hole 21 is defined through both the base 22 and the cover 24.

The base 22 is an annular plate. A plurality of light sources i.e. light emitting diodes 222 are arranged on a bottom surface of the base 22. The light emitting diodes 222 are arranged in two circles with different radius. In addition, the base 22 further defines a plurality of through holes 221 corresponding to the holes 141 of the bottom plate 142.

The cover 24 is located on the bottom surface of the base 22 with the light emitting diodes 222 facing toward the cover 24. The cover 24 is made of transparent or translucency material. In addition, an inner surface of the cover 24 can be formed with microstructures to obtain a uniform light output for the illumination device 100. The cover 24 includes an annular body 242, and an outer flange 244 and an inner flange 246 extending from an outer edge and an inner edge of the body 242, respectively. Three protruding platforms 248 extend upwardly from the body 242, and are located between the inner flange 246 and the outer flange 244. Each of the protruding platforms 248 defines two through holes 241 therein, corresponding to the two adjacent holes 141 at a same corner of the bottom plate 142, for connecting the cover 24, the base 22 and the lamp seat 10 together. When the cover 24 and the base 22 are assembled together, the inner flange 246 abuts against a bottom of the seat 22. In this embodiment, the inner edge 244 and the outer edge 246 each define a plurality of recesses (not labeled) therein to facilitate airflow flowing through the cover 24 thereby to obtain a better heat dissipation of the light emitting diodes 222.

During assembly of the illumination device 100, the electronic elements 16 are arranged in the space 18 inside the annular sidewall 144 of the lower cover 14. The upper cover 12 is connected with the lower cover 14 with the receiving chamber 126 aligned and communicating with the space 18, thereby to secure the electronic elements 16 between the upper cover 12 and the lower cover 14. In this embodiment, the upper cover 12 and the lower cover 14 are connected together by the first buckles 128 clasping with the second buckles 148. The cover 24 is attached to the bottom surface of the base 22 which have the light emitting diodes 222 mounted thereon. Rivets or screws are brought to extend through the through holes 241, 221 and secure in the holes 141 to fix the cover 24 and the base 22 to the lamp seat 10.

In the present illumination device 100, the protrusion 146 of the bottom plate 142 is configured to define a space 18 to receive the electronic elements 16 therein, and the protrusion 146 is inserted into the hole 21 of housing 20. Therefore, the thickness of the illumination device 100 can be effectively decreased. Moreover, the use of LEDs 222 as the light source can effectively lower the consumed power while have the same brightness.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An illumination device, comprising:
a housing defining a hole therethrogh;
a plurality of light sources disposed in the housing; and
a lamp seat securely positioned at one side of the housing, the lamp seat comprising a protrusion and receiving electronic elements therein, the protrusion of the lamp seat being inserted into the hole of the housing.

2. The illumination device of claim 1, wherein the light sources are light emitting diodes.

3. The illumination device of claim 2, wherein the lamp seat comprises an upper cover and a lower cover interconnected together, the upper cover is away from the housing, and the lower cover is adjacent to the housing, the upper cover and the lower cover cooperatively defining a space to receive the electronic components therein.

4. The illumination device of claim 3, wherein the upper cover comprises an upper plate and a lateral plate extending downwardly from the upper plate, and the upper plate and the lateral plate cooperatively define a receiving chamber to receive the electronic elements therein.

5. The illumination device of claim 4, wherein a central portion of the upper plate protrudes away from the housing.

6. The illumination device of claim 4, wherein the lamp seat has a trilobate shape.

7. The illumination device of claim 4, wherein the lateral plate of the upper cover comprises a snap extending horizontally from an inner side thereof towards a central of the upper cover, and a buckle is formed on the lower cover to clasp with the snap.

8. The illumination device of claim 3, wherein a first buckle and a second buckle are formed on the upper cover and the lower cover respectively, and the first buckle and the second buckle are clasped together to connect the upper cover with the lower cover together.

9. The illumination device of claim 8, wherein ends of the first buckle and the second buckle are bent to form hooks which are clasped with each other.

10. The illumination device of claim 4, wherein the lower cover comprises a bottom plate and an annular sidewall extending from the bottom plate to the upper cover.

11. The illumination device of claim 10, wherein one portion of the bottom plate surrounded by the sidewall protrudes outwardly away from the upper cover and forms the protrusion inserted into the hole of the housing, the protrusion being opposite to the sidewall, and the protrusion and the sidewall cooperatively define a space for receiving the electronic elements therein.

12. The illumination device of claim 1, wherein the housing comprises a base and a cover, the light sources are arranged on the base, the cover is located at one side of the base to cover the light sources, and the hole is defined in both the base and the cover.

13. The illumination device of claim 12, wherein the cover comprises an annular body, and an inner flange and an outer flange extending from an inner edge and an outer edge of the body respectively, and the inner flanges abuts a bottom of the lamp seat.

14. The illumination device of claim 13, wherein protruding platforms extend from the body and locate between the inner flange and the outer flange, the lamp seat and the base each define a plurality of holes therethrough, and the protruding platforms also define a plurality of through holes corresponding to the holes of the lamp seat and the base, the holes being configured for fixing the lamp seat and the housing together.
